(19) United States
(12) Patent Application Publication
(10) Pub. No.: US 2019/0243743 A1
(43) Pub. Date: Aug. 8, 2019

(54) UNSUPERVISED ANOMALY DETECTION

(71) Applicant: Apple Inc., Cupertino, CA (US)

(72) Inventors: Sumit Saxena, Sunnyvale, CA (US); Kushal M. Chawda, Campbell, CA (US); Ben-Heng Juang, Cupertino, CA (US); Arun G. Mathias, Los Altos, CA (US); Sairam T. Gutta, Cupertino, CA (US)

(21) Appl. No.: 15/968,684

(22) Filed: May 1, 2018

Related U.S. Application Data
(60) Provisional application No. 62/627,663, filed on Feb. 7, 2018.

(51) Int. Cl. G06F 11/36; G06N 3/04; G06F 17/30

(52) U.S. Cl. CPC G06F 11/3612; G06F 17/30371; G06N 3/0472; G06N 3/0445

(57) ABSTRACT

The subject technology extracts features from each log line of a log file. The subject technology determines, based on the features, a sequence of log lines. The subject technology determines probabilities of log lines occurring within a window of time from a respective log line from the sequence of log lines, and determines probabilities of periods of time within the window of time that a next log line will occur after the respective log line. The subject technology segments log lines from the log file into sequences of log lines based on the probabilities of the set of log lines occurring within the window of time and the probabilities of periods of time that the next log line occurs after the respective log line. The subject technology determines a predicted subsequent log line, and detects an anomaly when an actual subsequent log line differs from the predicted subsequent log line.

### CROSS-REFERENCE TO RELATED APPLICATIONS

The present application claims the benefit of U.S. Provisional Patent Application Ser. No. 62/627,663, entitled “UNSUPERVISED ANOMALY DETECTION,” filed Feb. 7, 2018, which is hereby incorporated herein by reference in its entirety and made part of the present U.S. Utility Patent Application for all purposes.

### TECHNICAL FIELD

The present description generally relates to anomaly detection including providing unsupervised anomaly detection for log files of applications executing on a given computing system or device.

### BACKGROUND

Existing techniques for anomaly detection of log files can require manual review by developers or system administrators, which can be difficult and inefficient. Other approaches for anomaly detection of log files may utilize regular expressions that can require frequent updating to adapt to changes in behavior from executing applications.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example network environment for providing unsupervised anomaly detection in accordance with one or more implementations.

FIG. 2 illustrates an example software architecture for providing unsupervised anomaly detection in log files in accordance with one or more implementations.

FIG. 3 illustrates an example log with log entries and corresponding example features in accordance with one or more implementations.

FIG. 4 illustrates a flow diagram of an example process for performing feature extraction and processing in accordance with one or more implementations.

FIG. 5 illustrates an example process for predicting probabilities of next log lines in accordance with one or more implementations.

FIG. 6 illustrates an example including a log lines sequence corresponding to extracted log keys and predicted probabilities of next log lines in accordance with one or more implementations.

FIG. 7 illustrates an example process for predicting a probability of a next log line occurring at a particular time in accordance with one or more implementations.

FIG. 8 illustrates an example prediction, based on a current log line and next log line, providing predicted probabilities of the next log line occurring over time buckets in accordance with one or more implementations of the subject technology.

FIG. 9 illustrates an example process for segmenting a log line to a new sequence or an existing sequence.

FIG. 10 illustrates example distributions of time for determining when a start of a sequence is indicated and when a start of a sequence is not indicated.

FIG. 11 illustrates an example segmentation of a new log line based on performing a window based segmentation of log lines.

FIG. 12 illustrates an example table for matching a log line to a segmented sequence.

FIG. 13 illustrates an example of flagging an anomaly within a sequence using segmented sequences of log lines in accordance with one or more implementations.

FIG. 14 illustrates an example of an interaction model utilizing previously aforementioned techniques of the subject technology when applied to a start and end of each intra-thread segmented sequence in accordance with one or more implementations.

FIG. 15 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

For a given computing environment, execution anomalies from executing applications on a computing system or device, including erroneous behavior or unexpected long response times, may cause losses of revenue and/or unsatisfactory user experiences. In an example, such anomalies may be caused by hardware problems, network communication congestion, and/or software bugs. Computing systems, in many cases, generate and store log messages from executing applications in log files for troubleshooting by developers and administrators. However, often times, anomalies are detected through manually checking system printed logs by a developer or administrator, or through the use of regular expressions that are inflexible and unable to adapt to changing behavior from applications (e.g., from updated software and/or code changes). As used herein, an anomaly refers to a log entry (e.g., a line within a log file) or a set of log entries that may not conform to expected behavior for a given application, lower level process, operating system, hardware component (e.g., processor, sensor, etc.), and/or other sources of log entries. Implementations of the subject technology described herein therefore are understood to process log entries that are provided from applications, lower level processes, operating systems, hardware components, and/or other sources of log entries.

Implementations of the subject technology described herein provide unsupervised anomaly detection techniques that may rely upon an implicit assumption that normal instances of log entries in log files are far more frequent than anomalies of log entries in the log files from unexpected behavior from applications running on a given computing device. In this manner, the subject technology can identify anomalies in log files, such as unstructured log files, without user intervention while also being adaptable to changing behavior of applications.

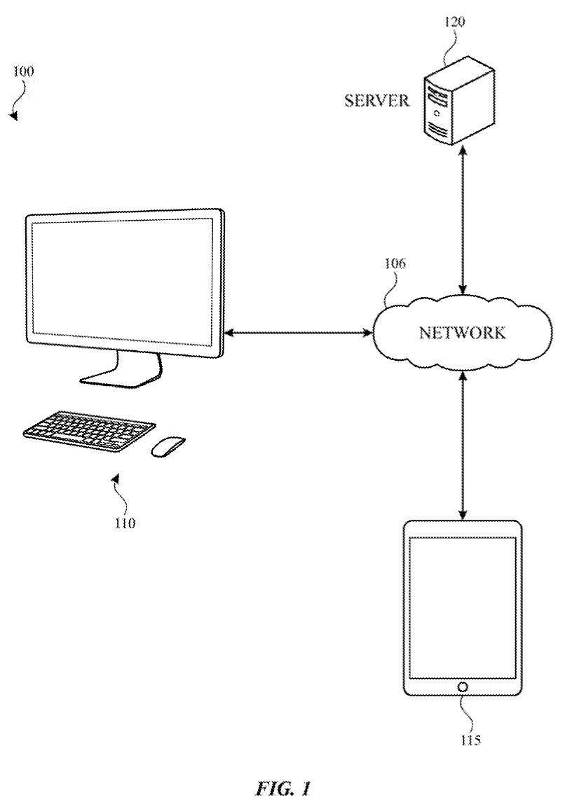

FIG. 1 illustrates an example network environment 100 for providing unsupervised anomaly detection in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, and a server 120. The network 106 may communicatively (directly or indirectly) couple the electronic device 110 and/or the server 120, the electronic device 115 and/or the server 120, and/or electronic device 110 and/or the electronic device 115. In one or more implementations, the network 106 may be an interconnected network of devices that may include, or may be communicatively coupled to, the Internet. For explanatory purposes, the network environment 100 is illustrated in FIG. 1 as including an electronic device 110, an electronic device 115, and a server 120; however, the network environment 100 may include any number of electronic devices and any number of servers.

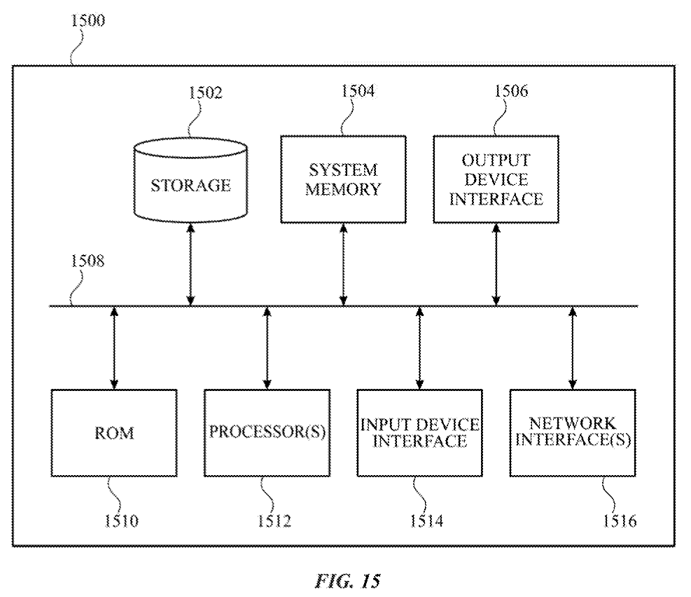

The electronic device 110 may be, for example, desktop computer, a portable computing device such as a laptop computer, a smartphone, a peripheral device (e.g., a digital camera, headphones), a tablet device, a wearable device such as a watch, a band, and the like, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 110 is depicted as a desktop computer. The electronic device 110 may be, and/or may include all or part of, the electronic system discussed below with respect to FIG. 15.

The electronic device 115 may include a touchscreen and may be, for example, a portable computing device such as a laptop computer that includes a touchscreen, a smartphone that includes a touchscreen, a peripheral device that includes a touchscreen (e.g., a digital camera, headphones), a tablet device that includes a touchscreen, a wearable device that includes a touchscreen such as a watch, a band, and the like, any other appropriate device that includes, for example, a touchscreen, or any electronic device with a touchpad. In one or more implementations, the electronic device 115 may not include a touchscreen but may support touchscreen-like gestures, such as in a virtual reality or augmented reality environment. In one or more implementations, the electronic device 115 may include a touchpad. In FIG. 1, by way of example, the electronic device 115 is depicted as a tablet device with a touchscreen. In one or more implementations, the electronic device 115 may be, and/or may include all or part of, the electronic device discussed below with respect to the electronic system discussed below with respect to FIG. 15.

The electronic device 110 and/or the electronic device 115 may include a framework that provides access to machine learning models as discussed herein. A framework can refer to a software environment that provides particular functionality as part of a larger software platform. In one or more implementations, the electronic devices 110 and/or 115 may include a framework that is able to access and/or execute machine learning models (e.g., a long short-term memory network, and a feed-forward neural network as discussed further herein), which may be provided in a particular software library in one implementation.

The electronic devices 110 and 115 may execute applications that populate one or more log files with log entries. For example, an application may execute code that prints out (e.g., writes) log entries into log files when performing operations in accordance with running the application, such as for debugging, monitoring, and/or troubleshooting purposes. The log entries may correspond to error messages and/or to unexpected application behavior that can be detected as anomalies using the subject technology. Examples of anomalies include errors in connection with work flow that occur during execution of the application, while some other anomalies are connected to low performance where the execution time takes much longer than expected in normal cases although the execution path is correct.

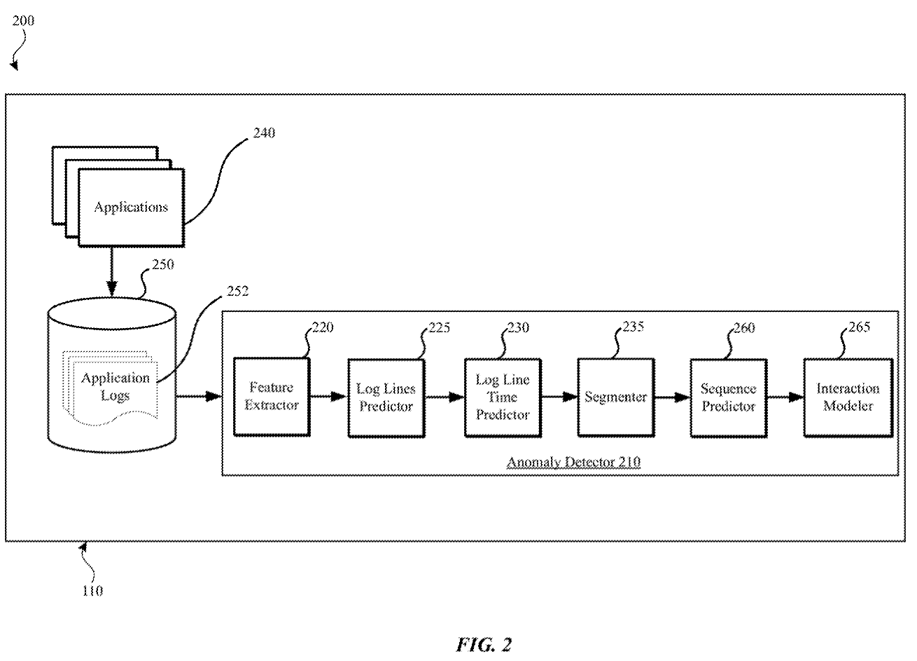

FIG. 2 illustrates an example software architecture 200 for providing unsupervised anomaly detection in log files in accordance with one or more implementations. In the example of FIG. 2 as described below, the software architecture 200 is provided by the electronic device 110 of FIG. 1, such as by a processor and/or memory of the electronic device 110; however, it is appreciated that, in some examples, the software architecture 200 may be implemented at least in part by any other electronic device (e.g., electronic device 115). Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated, the software architecture 200 includes a memory 250 including application logs 252. In an example, each of the application logs 252 may be stored as one or more log files with multiple log lines in the memory 250. Each log entry may correspond to a log line in a given log file. Applications 240 may be executing on the electronic device 110 and provide log entries that are stored within one or more of the application logs 252. Each of the applications 240 may include one or more threads (e.g., a single threaded or multiple threaded application) in which a thread may be performing operations for the application. A given application with multiple threads can therefore perform respective operations concurrently in respective threads.

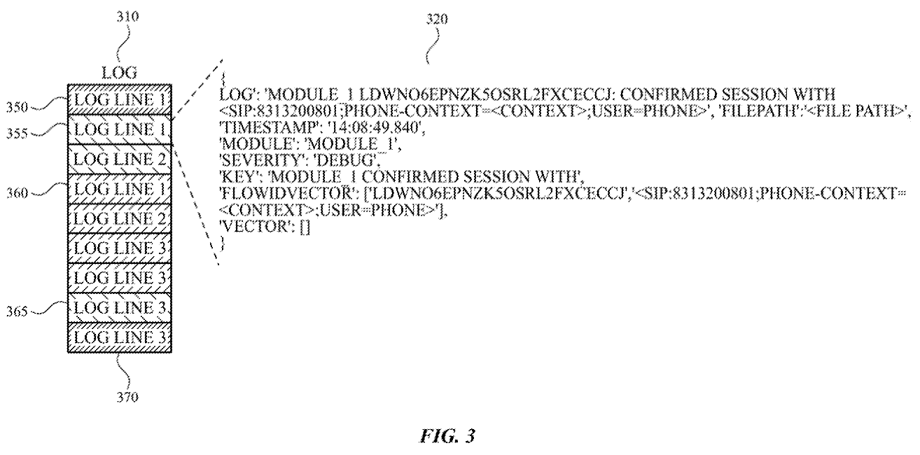

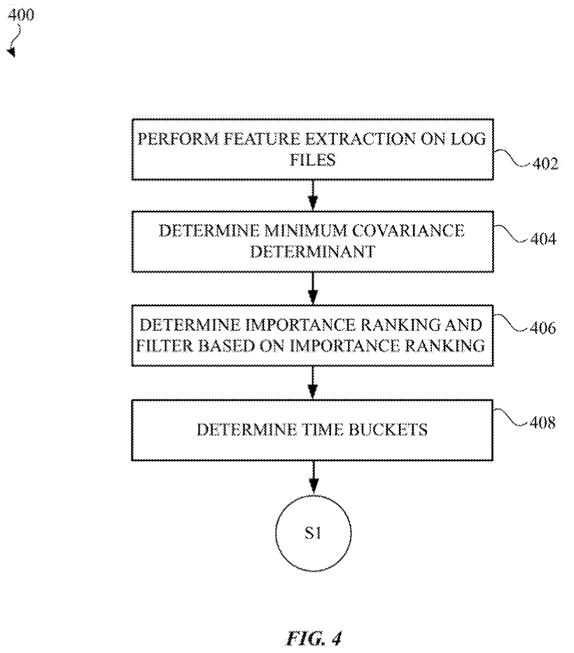

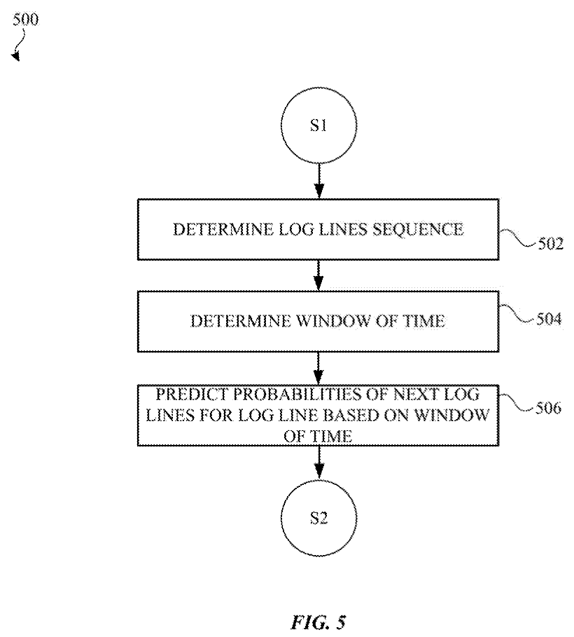

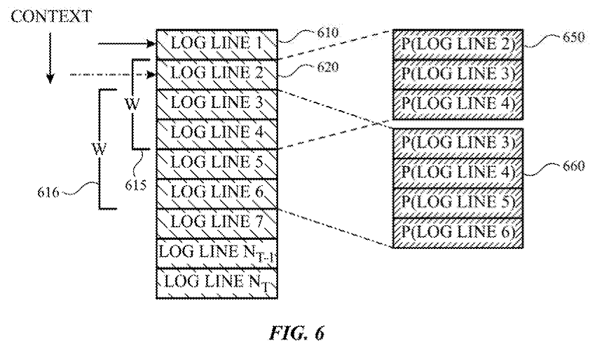

As further shown, the software architecture 200 includes an anomaly detector 210. The anomaly detector 210 has several components including feature extractor 220, log lines predictor 225, log line time predictor 230, a segmenter 235, a sequence predictor 260, and an interaction modeler 265. Each of the application logs 252 may undergo feature extraction and processing performed by the feature extractor 220, which are discussed in further detail in FIGS. 3 and 4 below. After feature extraction and processing, the log lines predictor 225 determines, on a per-thread basis, probabilities of next log lines that occur within a window of time, which are discussed in FIGS. 5 and 6 below. Given a particular log line from the log lines predictor 225, the log line time predictor 230 predicts a probability of a next log line occurring at a particular time. The segmenter 235 segments a given log line to a particular sequence. The sequence predictor 260 predicts probabilities of a next sequence element (e.g., next segment of the sequence corresponding to a log line). The interaction modeler 265 models interaction between threads using features determined from feature extraction.

FIG. 3 illustrates an example including a log 310 with log entries and corresponding example features 320 in accordance with one or more implementations of the subject technology.

As illustrated, the example log 310 includes multiple log lines. Each log line may correspond to a particular thread of an application executing on the electronic device 110. For instance, a log line 350 and a log line 370 correspond to a first thread. A log line 355, subsequent log lines, and a log line 365 correspond to a second thread. Further, a log line 360 and the subsequent three log lines correspond to a third thread. As an example, the feature extractor 220 determines multiple features 320 from the log line 355 including the text string of the log line 355, a timestamp, a corresponding thread (“module”), a key, and a flow identifier vector. The key corresponds to an identifier representing a family of log lines that include the value of the key (e.g., common content of log entries that are outputted by the same log output statement in code), the flow identifier vector represents vectors that represent a flow. As used herein, a flow can refer to a sequence of log entries of a given thread that is currently executing. A given log file therefore can be understood as including a garbled sequence of multiple flows. For each log line, a respective key may be determined using heuristic techniques based on, for example, keeping strings of wholly alphabetic characters and discarding alphanumeric strings. It is appreciated that other types of heuristic techniques may also be applied. Additionally, in an example, a dictionary of determined keys may be utilized to form a vocabulary of log keys, which in turn may be used in connection with performing feature extraction discussed below in FIG. 4. It is further appreciated that a respective dictionary of determined keys may be generated for each thread.

FIG. 4 illustrates a flow diagram of an example process 400 for performing feature extraction and processing in accordance with one or more implementations. For explanatory purposes, the process 400 is primarily described herein with reference to components of the software architecture of FIG. 2 (particularly with reference to the feature extractor 220), which may be executed by one or more processors of the electronic device 110 of FIG. 1. However, the process 400 is not limited to the electronic device 110, and one or more blocks (or operations) of the process 400 may be performed by one or more other components of other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations. The process 400 below may be performed by the feature extractor 220 in order to determine features, on a per-thread basis, from log files with respective log entries.

The feature extractor 220 performs feature extraction on a log file (402). In one or more implementations, a given log line corresponding to a particular log entry in the log file includes three different items: 1) a timestamp; 2) a thread identifier; and 3) a log message string. To generate features for a given log line, the feature extractor 220 may perform, for each log key in a dictionary of log keys, the following description of operations.

In one or more implementations, the feature extractor 220 generates a vector that includes the following features: 1) a frequency percentile based on a determined 98th percentile of a log line key frequency across all log files; 2) a percentage of log files that the log line key is present in; 3) maximum consecutive repetitions based on the determined 98th percentile of log line key consecutive repetitions across all log files; and 4) maximum alternative repetitions based on the determined 98th percentile of the log line key alternate repetitions across all log files. The feature extractor 220 aggregate all vectors to form a data matrix, such that each row provides the above four features for a log key of a single log line. The feature extractor 220 then performs median normalization (column wise).

In one or more implementations, the feature extractor 220 determines a minimum covariance determinant (MCD) (404). In one or implementations, the feature extractor 220 determines a fit fast MCD on the data matrix with the following parameters: a) assume_centered=True; and b) support_fraction=1.0. The feature extractor 220 determines a decision boundary greater than or equal to (=>) a Mahalanobis distance for each row (e.g., corresponding to a log line key). The feature extractor 220 determines a column wise median and standard deviation (std) of the data points. The feature extractor 220 determines: a max allowed range of all columns ==median+2.0 * std (column wise).

The feature extractor 220 determines an importance ranking and performs filtering based on the importance ranking (406) by performing the operations in the following description. The feature extractor 220 determines: 1) for all rows that have a Mahalanobis distance greater than (>) a model threshold (negative prediction by Fast MCD): a) for all columns less than or equal to (<=) a max allowed range of each column then add to a positive rank of the row; b) else add to a negative rank of the row. The feature extractor 220 then filters all rows with a negative rank.

The feature extractor 220 determines multiple time buckets (408). A time bucket as referred to herein corresponds to a period of time which has elapsed since a previous log entry was written into a log file. The multiple time buckets, in an example, may be utilized by the feature extractor 220 to further filter outliers in the feature dataset. In one or more implementations, the feature extractor 220 may perform the operations in the following description. The feature extractor 220, for each log line key, calculates a time difference in milliseconds (ms) with a next log line and stores the time difference in a list T. The feature extractor 220 sorts list T. The feature extractor 220 determines different time buckets corresponding to the following notation: timeBins[0]=0 ms; timeBins[1]=60 percentile of T; timeBins[−1]=max_ts=min(5 min, 95 percentile of T). In an example, the value of max_ts corresponds to a minimum value between a first value of the 95^{th} percentile of the data in T and a second value of five (5) minutes.

The feature extractor 220, for the rest of the data in T (60 percentile to max_ts), performs a K-means clustering with an elbow method to determine optimal centroids. The feature extractor 220 then determines values of the time buckets based on the optimal centroids in accordance with the following notation: timeBins=CalculateBinsBasedOnCentroid(optimal centroids). The feature extractor 220 sets a window cutoff in accordance with the following notation: set window cutoff=avg(timeBins[2]+timeBins[3]). The feature extractor 220 then sets a negative sampling cutoff based on the following notation: set NegativeSamplingCutoff=1.3 * max_ts. In an example, the negative sampling cutoff corresponds to thirty percent more than a maximum window set by max_ts.

In one or more implementations, the feature extractor 220 may utilize the following code to determine the “CalculateBinsBasedOnCentroid(optimal centroids)” discussed above:

```
CalculateBinsBasedOnCentroid(optimalCentroids) {
timeBins = list( )
for i in range(len(optimalCentroids)−1):
  bin = (optimalCentroids[i] + optimalCentroids[i+1]) / 2.0
  bin = np.ceil(bin)
  timeBins.append(bin)
return timeBins
}
```

The process 400 may then complete, and a process 500 described in FIG. 5 may be performed by the electronic device 110.

FIG. 5 illustrates an example process 500 for predicting probabilities of next log lines in accordance with one or more implementations. For explanatory purposes, the process 500 is primarily described herein with reference to components of the software architecture of FIG. 2 (particularly with reference to the log lines predictor 225), which may be executed by one or more processors of the electronic device 110 of FIG. 1. However, the process 500 is not limited to the electronic device 110, and one or more blocks (or operations) of the process 500 may be performed by one or more other components of other suitable devices. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations. The process 500 may be performed by the log lines predictor 225 to determine, on a per-thread basis, probabilities of next log lines that occur within a window of time. Further, the process 500 may be performed in conjunction with the process 400 (e.g., after the process 400 completes).

The log lines predictor 225 determines a log lines sequence (502). In an example, a log lines sequence may include a number of log lines from 1 to n (e.g., [1, 2, 3 . . . nₜ₋₁, nₜ]) corresponding to a particular thread (e.g., based on the thread ID) from a given log file.

The log lines predictor 225 determines a window of time (e.g., in milliseconds) (504). The window of time may be dynamically calculated on a per-thread basis and determines a duration of time after a given log line that next log lines may occur. In an example, the dynamically determined window of time corresponds to a duration of time

The log lines predictor 225 determines, for a given log line and the window of time, the probabilities of next log lines occurring within the window of time (506). Each of the log lines may correspond to a respective log key that was previously determined by the feature extractor 220, and the log lines sequence may include respective log lines associated with a particular flow (e.g., based on the flow identifier vector). The log lines predictor 225, in an example, utilizes a long short-term memory (LSTM) network to determine the probabilities and takes in the window of time as a parameter. In one or more implementations, the LSTM network may utilize techniques including layer normalization, dropout (e.g., a regularization method where input and recurrent connections to LSTM units are probabilistically excluded from activation and weight updates while training a network), and/or binary cross-entropy. Each log key may also be processed using a word embedding technique to associate with other similar log keys (e.g., clustering).

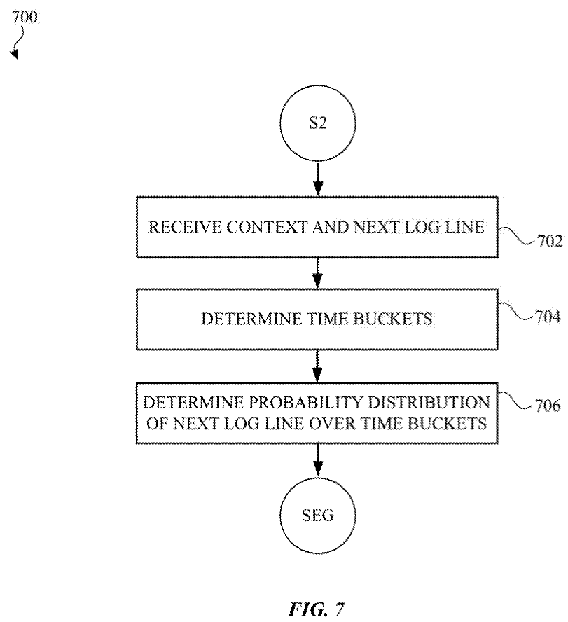

For each subsequent log line within the received log lines sequence, the log lines predictor 225 may repeat and determine the probabilities of next log lines occurring within the window of time (506). The process 500 may then complete, and a process 700 described in FIG. 7 may be performed by the electronic device 110.

FIG. 6 illustrates an example including a log lines sequence corresponding to extracted log keys (e.g., as determined by the feature extractor 220 on a given log file) and predicted probabilities of next log lines in accordance with one or more implementations of the subject technology. The log lines sequence with the multiple log lines corresponds to the same thread in the example of FIG. 6.

Initially, the log lines predictor 225 may select log line 610 and determine probabilities 650 for a set of next log lines that occur within a window of time 615. Although three probabilities are shown for the purposes of illustration, it is understood that the log lines predictor 225 may determine a respective probability of each log key in a dictionary of log keys (e.g., determined by the feature extractor 220). Next, the log lines predictor 225 may select log line 620 and determine probabilities 650 for a set of next log lines that may occur within a subsequent window of time 616. In an example, the windows of time 615 and 616 may be equal in duration. Alternatively, the window of time 615 and 616 may be different values. For each of the log lines illustrated in the example, the log lines predictor 225 may determine respective probabilities for a set of next log lines based on a window of time (e.g., the window of time 615 or 616).

FIG. 7 illustrates an example process 700 for predicting a probability of a next log line occurring at a particular time in accordance with one or more implementations. For explanatory purposes, the process 700 is primarily described herein with reference to components of the software architecture of FIG. 2 (particularly with reference to the log line time predictor 230), which may be executed by one or more processors of the electronic device 110 of FIG. 1. However, the process 700 is not limited to the electronic device 110, and one or more blocks (or operations) of the process 700 may be performed by one or more other components of other suitable devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations. Given a particular log line, the process 700 may be performed by the log line time predictor 230 to predict a probability of a next log line occurring on a per-thread basis. Further, the process 700 may be performed in conjunction with the process 500 (e.g., after the process 500 completes).

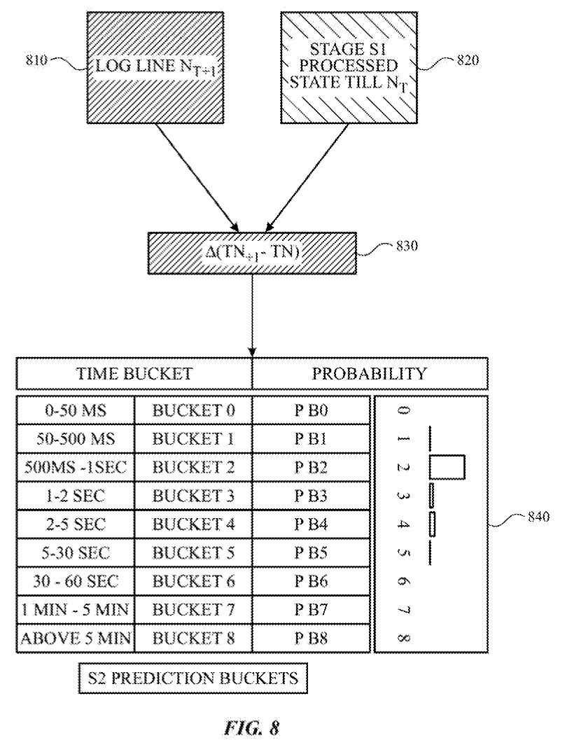

The log line time predictor 230 receives a context and next log line (702). The received context may correspond to the log lines sequence from the log lines predictor 225. The log line time predictor 230 determines a set of time buckets (704). In an example, the time buckets may be determined based on statistical techniques. The log line time predictor 230 determines a probability distribution over the determined time buckets (706). In an example, the log line time predictor 230 utilizes a feed-forward neural network in order to determine the probability distribution. The feed-forward neural network may utilize techniques including categorical cross-entropy and a softmax function. A negative sampling technique is also utilized by the log line time predictor 230 to increase the accuracy of the prediction. An example of the probability distribution determined by the log line time predictor 230 is shown in FIG. 8.

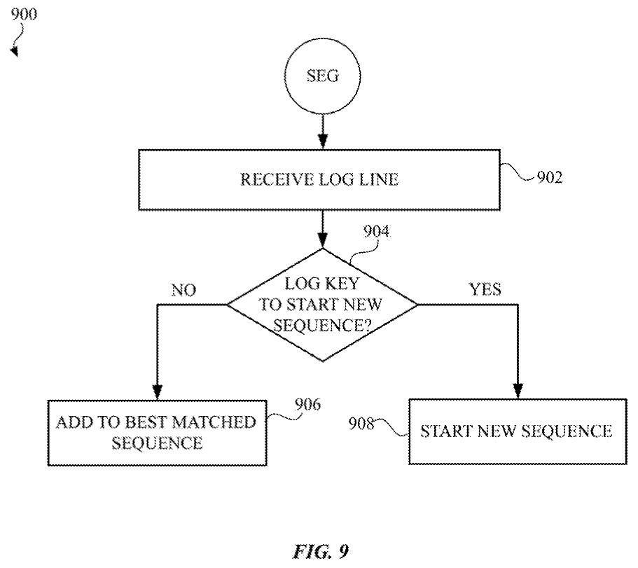

The process 700 may then complete, and a process 900 described in FIG. 9 may be performed by the electronic device 110.

FIG. 8 illustrates an example prediction (e.g., provided by log line time predictor 230), based on a current log line 820 and next log line 810, providing predicted probabilities 840 of the next log line 810 occurring over time buckets in accordance with one or more implementations of the subject technology. In the example of FIG. 8, a time bucket corresponding to 500 ms-1 sec is indicated as having the highest probability for a time 830 (e.g., representing the difference in time from a time that the next log line 810 occurs and a time that the current log line occurred) in which the next log line 810 is to occur after the current log line 820.

FIG. 9 illustrates an example process 900 for segmenting a log line to a new sequence or an existing sequence in accordance with one or more implementations. For explanatory purposes, the process 900 is primarily described herein with reference to components of the software architecture of FIG. 2 (particularly with reference to the segmenter 235), which may be executed by one or more processors of the electronic device 110 of FIG. 1. However, the process 900 is not limited to the electronic device 110, and one or more blocks (or operations) of the process 900 may be performed by one or more other components of other suitable devices. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations. Given a particular log line, the process 900 may be performed by the segmenter 235 to segment a given log line to a particular sequence and/or determine that the log line is the start of a new sequence. As used herein, a sequence may refer to a set of log lines associated with a path of execution through code of an application (e.g., corresponding to a particular thread of the application). In an example, a sequence may correspond to log lines for a particular transaction (e.g., one or more operations that succeed or fail as a complete unit) that is being processed by the application. In another example, a sequence may correspond to log lines associated with a request and a response to the request.

The segmenter 235 may determine a start of a new sequence based on a new log line and its associated log key. The segmenter 235 may utilize a probability of a new key and a probability of a new time bucket in determining the start of a new sequence. A new sequence is instantiated if the new log line key belongs to a start of a sequence. Existing sequences may be matched based on a best matching score.

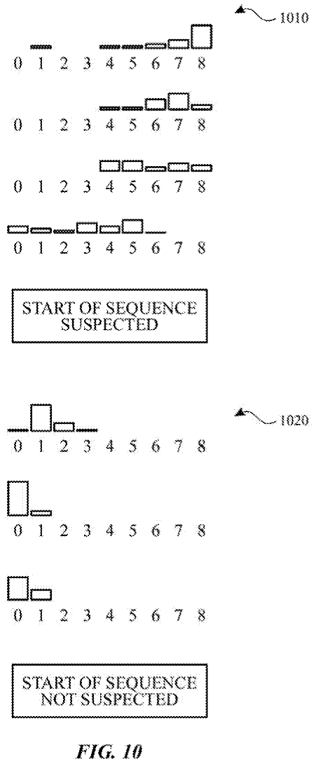

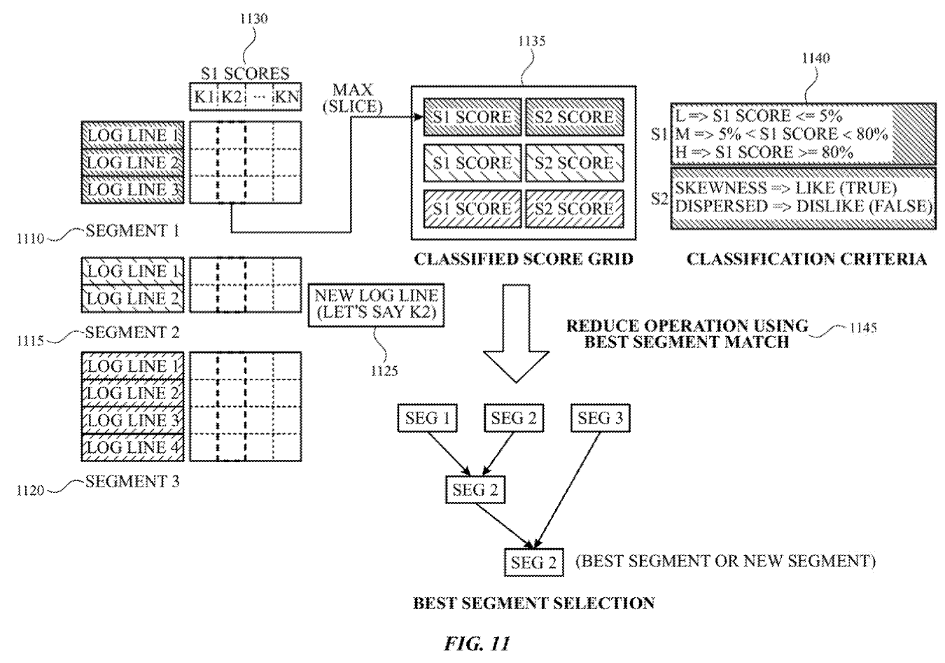

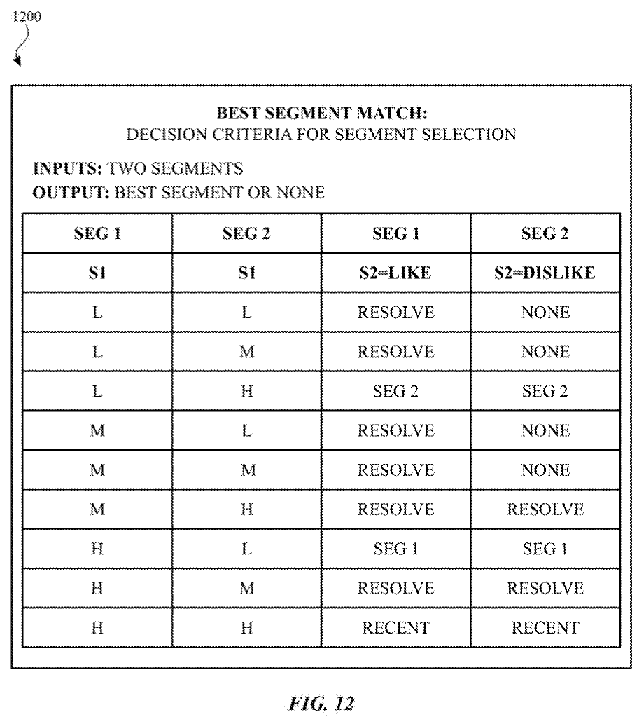

The segmenter 235 receives a log line (902). The segmenter 235 determines whether a log key of the log line starts a new sequence (904) or alternatively belongs to a particular sequence based on matching techniques discussed further below. In an example, log lines that correspond to a potential start of a sequence are aggregated and put to a vote (e.g., via ensemble methods). The segmenter 235 identifies a potential start of a new sequence when start delimiters are detected. Examples indicators of start delimiters are discussed in FIG. 10 below. Respective log lines that accumulate enough votes (e.g., based on a voting threshold) are segmented to a start of a new sequence (908). When the segmenter 235 determines that the log key does not indicate a start of a new sequence, the segmenter 235 performs a best matching algorithm to match the log key to a particular sequence (906). An example best matching algorithm is discussed in further detail in FIGS. 11 and 12 below.

FIG. 10 illustrates example distributions of time for determining when a potential start of a sequence is indicated and when a potential start of a sequence is not indicated. A potential start of a sequence is indicated in different example time buckets 1010 because there is not a strong correlation to any particular time bucket. A potential start of a sequence is not indicated in different example time buckets 1020, which indicates a strong correlation to one time bucket.

FIG. 11 illustrates an example segmentation of a new log line based on performing a window based segmentation of log lines, which may be performed by the segmenter 235.

As illustrated, three different segments 1110, 1115, and 1120 are shown which may correspond to portions of respective segmented sequences. A new log line 1125 (e.g., “K2”) is received by the segmenter 235. In an example, the segmenter 235 selects a maximum value from a particular column (e.g., the K2 column corresponding to the new log line 1125) of S1 scores 1130 (e.g., determined by the log lines predictor 225) representing different predicted probabilities of respective log lines of a particular segment. The segmenter 235 determines how much the three different segments 1110, 1115, and 1120 “like” the new log line 1125 based on a classified score grid 1135 including respective selected S1 scores and S2 scores. The segmenter 235 utilizes classification criteria 1140 for classifying respective S1 scores and S2 scores to different categories. For example, a given S1 score can be categorized to a low, medium, or high score category, and a given S2 score can be categorized to a “Like” or “Dislike” category. In an example, a given S1 score is based on determining a maximum value from a column corresponding to the log key of the new log line, in which the column corresponds to an eligible parent slice that includes Si scores for matching the column within a window of time.

A given S2 score that categorizes the new log line 1125 as a “Like” indicates that it was able to predict that the new log line 1125 occurred at a particular time within a time window. In an example, a given S2 score is based on the following:

S2 Score: S2 Softmax Skewness Score of Time Buckets (New line, Last line of segment)

The segmenter 235 performs a reduce operation on the scores from the classified score grid 1135 to determine a best segment selection or a new segment.

In one or more implementations, the segmenter 235 may detect a dual start key when two segments may have respective Si scores that are both “high” score categories for the new log line 1125. In this case, the new log line 1125 is associated to a recent segment (e.g., as illustrated in the last row of a table 1200 in FIG. 12). A dual start key as used herein may refer to a log key that indicates a start of an event within a previous event that has yet to end and is still continuing (e.g., a timeout that is started within a previous timeout). The segmenter 235 performs a reduce operation using a best segment match 1145 to determine a segment to assign with the new log line 1125.

FIG. 12 illustrates an example table for matching a log line to a segmented sequence. FIG. 12 will be discussed in connection with the segmenter 235 and reference portions of FIG. 11.

As shown, the table 1200 includes decision criteria for segment selection based on two respective segments that are provided as inputs. The output results in the new log line 1125 being associated to a determined best segment among the two input segments or not being assigned to any of the two input segments. In an example, if the new log line 1125 is not associated to any of the input segments, then the new log line 1125 is considered the start of a new segmented sequence.

In rows in the table 1200 in which S2 scores indicate a “Resolve” operation, the segmenter 235 may apply a resolve algorithm used in the example of FIG. 12 may utilize the following to select a particular segment for output:

```
Input: seg1, seg2
if abs(seg1_s1_prob − seg2_s1_prob) <= THRESHOLD
        return recent (seg1, seg2)
else:
        if seg1_s1_prob > seg2_s1_prob:
                return seq1
else:
        return seg2
```

Based on the result of the resolve algorithm, the segmenter 235 outputs the particular segment (e.g., segment 1 or segment 2 that were provided as inputs) as the selected segment to assign with the new log line 1125.

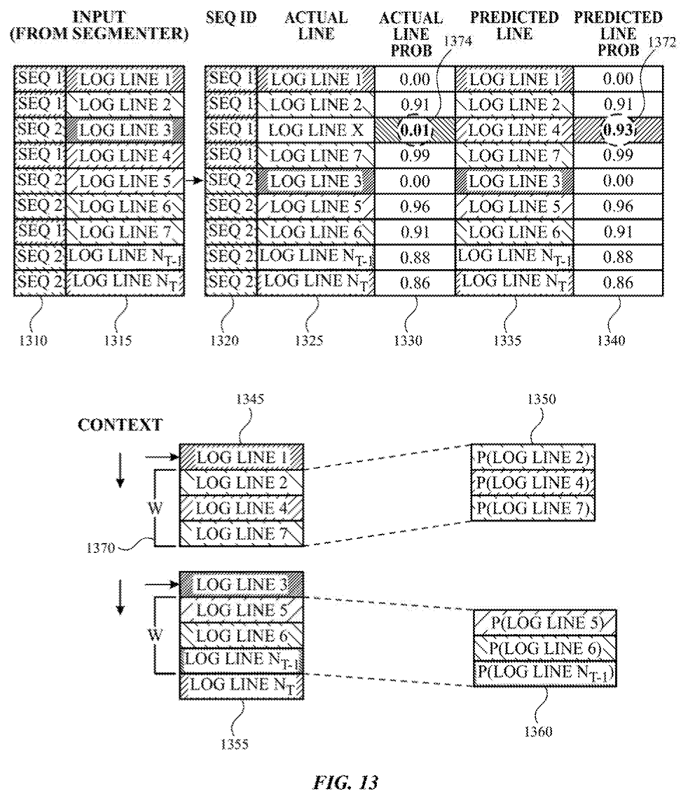

FIG. 13 illustrates an example of flagging an anomaly within a sequence using segmented sequences of log lines in accordance with one or more implementations. In an example, the sequence predictor 260 utilizes similar machine learning techniques, such as a LSTM network that are applied by the log lines predictor 225, except that the sequence predictor 260 applies such techniques to segmented sequences of log lines (e.g., received from the segmenter 235) instead of garbled log lines. In an implementation, the LSTM network is reset at the end of each segmented sequence of log lines. Additionally, the LSTM network in the example of FIG. 13 provides a good deterministic bias for converting a given sequence of log lines to a vector.

As illustrated, the sequence predictor 260 may receive input including segmented sequences 1310 that are associated with log lines 1315. The sequence predictor 260 may train on segmented sequences 1310 and provide as output the probabilities of a next sequence deterministically. As illustrated, the sequence predictor 260 groups segmented sequences 1320, determines respective probabilities 1330 for actual log lines 1325, and determines predicted probabilities 1340 corresponding to predicted log lines 1335.

In further examples, the sequence predictor 260 may analyze the probabilities of each of the actual log lines 1325 and identify anomalies based on probabilities that are below a predetermined probability threshold value. In an example, the log line corresponding to “Log Line X” with a probability 1374 of 0.01 is flagged as an anomaly due to having a probability differential greater than a threshold when compared to a probability 1372 of 0.93 of the corresponding predicted log line of “Log Line 4” and/or also by virtue of the “Log Line X” not matching the predicted log line of “Log Line 4.” In one or more implementations, when an anomaly is detected, the anomaly detector 210 transmits an alert or notification, or can take one or more corrective actions. An example of a corrective action includes terminating a thread associated with the anomaly, or shutting down an application executing the thread.

In an example, based on an actual log line from a particular segmented sequence of log lines (e.g., “Log Line 1” from sequence 1 of the actual log lines 1325), the sequence predictor 260 may determine a predicted subsequent log line (e.g., “Log Line 4” from predicted log lines 1335). The sequence predictor 260 may dynamically calculate a window of time 1370 (e.g., on a per-thread basis), and determine a probability 1372 that the predicted subsequent log line (e.g., “Log Line 4”) occurs within the window of time 1370. The sequence predictor 260 detects an anomaly when an actual subsequent log line (e.g., “Log Line X”) differs from the predicted subsequent log line (e.g., “Log Line 4”) in one example. Moreover, the sequence predictor 260 can detect an anomaly when the actual subsequent log line differs from the predicted subsequent log line and a probability 1372 associated with the predicted subsequent log line exceeds a predetermined threshold (e.g., based on a difference between the probability 1372 and the probability 1374).

The sequence predictor 260 determines probabilities for next log lines 1350 and 1360 for context 1345 (e.g., corresponding to segmented sequence 1) and context 1355 (e.g., corresponding to segmented sequence 2), respectively. In further examples, the output of the sequence predictor 260 may map sequences to a deterministic vector (state), and also may be used for duplicate detection. As shown, contexts 1345 and 1355 may be used to compare against other segmented sequences for duplicate detection.

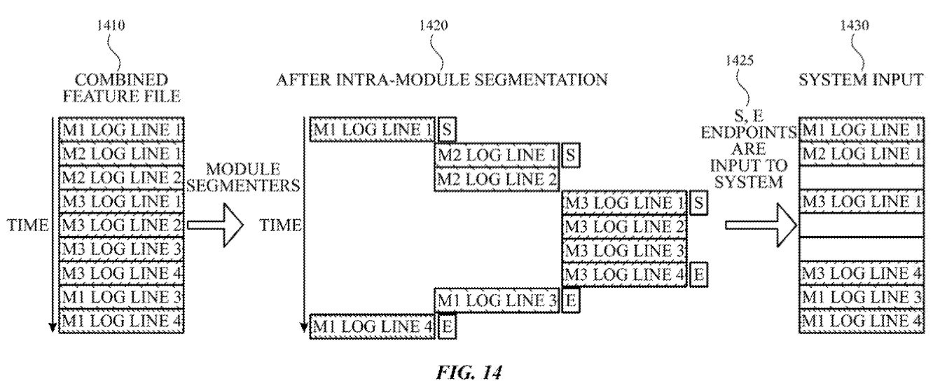

FIG. 14 illustrates an example of an interaction model utilizing previously aforementioned techniques of the subject technology when applied to a start and end of each intra-thread segmented sequence in accordance with one or more implementations. In particular, FIG. 14 illustrates an example of modeling the interaction between threads that are executing on the electronic device 110. The interaction modeler 265 provided by the electronic device 110, in an example, may utilize machine learning techniques to model the interaction between segmented sequences within the same thread.

The interaction modeler 265 may be provided with the first and last log lines of each intra-thread segmented sequence (e.g., a sequence occurring within a particular thread). A combined feature file 1410 which includes all segmented sequences for a particular thread may undergo an intra-thread segmentation 1420 to group and chronically align the log lines for each segmented sequence from the combined feature file 1410. Respective log lines that correspond to a starting log line and ending log line 1425 for each segmented sequence are provided as input to the interaction modeler 265 in order to provide an abstraction 1430 of each segmented sequence. The interaction modeler 265 may then apply machine learning techniques to determine probabilities related to these respective starting and ending log lines.

FIG. 15 illustrates an electronic system 1500 with which one or more implementations of the subject technology may be implemented. The electronic system 1500 can be, and/or can be a part of, the electronic device 110, the electronic device 115, and/or the server 120 shown in FIG. 1. The electronic system 1500 may include various types of computer readable media and interfaces for various other types of computer readable media. The electronic system 1500 includes a bus 1508, one or more processing unit(s) 1512, a system memory 1504 (and/or buffer), a ROM 1510, a permanent storage device 1502, an input device interface 1514, an output device interface 1506, and one or more network interfaces 1516, or subsets and variations thereof.

The bus 1508 collectively represents all system, peripheral, and chipset buses that communicatively connect the numerous internal devices of the electronic system 1500. In one or more implementations, the bus 1508 communicatively connects the one or more processing unit(s) 1512 with the ROM 1510, the system memory 1504, and the permanent storage device 1502. From these various memory units, the one or more processing unit(s) 1512 retrieves instructions to execute and data to process in order to execute the processes of the subj ect disclosure. The one or more processing unit(s) 1512 can be a single processor or a multi-core processor in different implementations.

The ROM 1510 stores static data and instructions that are needed by the one or more processing unit(s) 1512 and other modules of the electronic system 1500. The permanent storage device 1502, on the other hand, may be a read-and-write memory device. The permanent storage device 1502 may be a non-volatile memory unit that stores instructions and data even when the electronic system 1500 is off. In one or more implementations, a mass-storage device (such as a magnetic or optical disk and its corresponding disk drive) may be used as the permanent storage device 1502.

In one or more implementations, a removable storage device (such as a floppy disk, flash drive, and its corresponding disk drive) may be used as the permanent storage device 1502. Like the permanent storage device 1502, the system memory 1504 may be a read-and-write memory device. However, unlike the permanent storage device 1502, the system memory 1504 may be a volatile read-and-write memory, such as random access memory. The system memory 1504 may store any of the instructions and data that one or more processing unit(s) 1512 may need at runtime. In one or more implementations, the processes of the subject disclosure are stored in the system memory 1504, the permanent storage device 1502, and/or the ROM 1510. From these various memory units, the one or more processing unit(s) 1512 retrieves instructions to execute and data to process in order to execute the processes of one or more implementations.

The bus 1508 also connects to the input and output device interfaces 1514 and 1506. The input device interface 1514 enables a user to communicate information and select commands to the electronic system 1500. Input devices that may be used with the input device interface 1514 may include, for example, alphanumeric keyboards and pointing devices (also called “cursor control devices”). The output device interface 1506 may enable, for example, the display of images generated by electronic system 1500. Output devices that may be used with the output device interface 1506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 15, the bus 1508 also couples the electronic system 1500 to one or more networks and/or to one or more network nodes, such as the electronic device 110 shown in FIG. 1, through the one or more network interface(s) 1516. In this manner, the electronic system 1500 can be a part of a network of computers (such as a LAN, a wide area network (“WAN”), or an Intranet, or a network of networks, such as the Internet. Any or all components of the electronic system 1500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
extracting features from each log line of a log file;
determining, based on the extracted features, a sequence of log lines, the sequence of log lines including multiple log lines that occur in chronological order;
determining, for each respective log line from the sequence of log lines, probabilities of a set of log lines occurring within a predetermined window of time from the respective log line from the sequence of log lines;
determining, for each respective log line from the sequence of log lines, probabilities of different periods of time within the predetermined window of time that a next log line will occur after the respective log line from the sequence of log lines;
segmenting respective log lines from the log file into respective sequences of log lines based at least in part on the probabilities of the set of log lines occurring within the predetermined window of time and the probabilities of different periods of time that the next log line occurs after the respective log line;
determining a predicted subsequent log line based at least in part on an actual log line from the respective sequences of log lines and a second predetermined window of time; and
detecting an anomaly when an actual subsequent log line differs from the predicted subsequent log line.

2. The method of claim 1, wherein each log line includes a timestamp, a thread identifier, and a log message string, each log line corresponding to a thread of an application.

3. The method of claim 1, wherein extracting features from the log file further comprises:
for each unique log key from the extracted features of each log line, generating a vector for the unique log key, the vector including values comprising a frequency percentile of the unique log key, a percentage of logs files that the unique log key is present in, a maximum number of consecutive repetitions, and a maximum number alternative repetitions;
aggregating vectors corresponding to the generated vector for each unique log key, the aggregated vectors forming a data matrix including rows for each unique log key;
performing median normalization on the values of the data matrix to provide a normalized data matrix;
determining a minimum covariance determinant of the values of the normalized data matrix; and
filtering rows of the normalized data matrix based at least in part on a Mahalanobis distance of the rows being greater than a predetermined threshold, the predetermined threshold being determined based at least in part on the minimum covariance determinant.

4. The method of claim 1, wherein determining the probabilities of the set of log lines occurring within the predetermined window of time is based on a long short-term memory network.

5. The method of claim 1, wherein determining the probabilities of the set of log lines occurring within the predetermined window of time is based on a feed-forward neural network.

6. The method of claim 1, wherein the different periods of time correspond to a number of respective consecutive periods of time occurring after each log line, and the probabilities of different periods of time correspond to a probability distribution over the different periods of time.

7. The method of claim 1, wherein detecting the anomaly when the actual subsequent log line differs from the predicted subsequent log line further comprises:
detecting the anomaly when the actual subsequent log line differs from the predicted subsequent log line and a probability associated with the predicted subsequent log line exceeds a threshold.

8. The method of claim 1, further comprising:
sending a notification in response to the detected anomaly.

9. The method of claim 1, wherein segmenting respective log lines from the log file into respective sequences of log lines further comprises:
matching a particular log line to a particular sequence of log lines based on a score.

10. The method of claim 1, wherein the probability that the respective log line occurs within the respective sequences of log lines indicates a lower probability in comparison to a predicted log line.

11. A system comprising;
a processor;
a memory device containing instructions, which when executed by the processor cause the processor to:
extract features from each log line of a log file;
receive, based on the extracted features, a sequence of log lines, the sequence of log lines including multiple log lines that occur in chronological order;
determine, for each respective log line from the sequence of log lines, probabilities of a set of log lines occurring within a predetermined window of time from the respective log line from the sequence of log lines;
determine, for each respective log line from the sequence of log lines, probabilities of different periods of time within the predetermined window of time that a next log line will occur after the respective log line from the sequence of log lines;
segment respective log lines from the log file into respective sequences of log lines based at least in part on the probabilities of the set of log lines occurring within the predetermined window of time and the probabilities of different periods of time that the next log line occurs after the respective log line;
determine a predicted subsequent log line based at least in part on an actual log line from the respective sequences of log lines and a second predetermined window of time; and
detect an anomaly when an actual subsequent log line differs from the predicted subsequent log line.

12. The system of claim 11, wherein each log line includes a timestamp, a thread identifier, and a log message string, each log line corresponding to a thread of an application.

13. The system of claim 11, wherein to extract features from the log file further causes the processor to:
for each unique log key from the extracted features of each log line, generate a vector for the unique log key, the vector including values comprising a frequency percentile of the unique log key, a percentage of logs files that the unique log key is present in, a maximum number of consecutive repetitions, and a maximum number alternative repetitions;
aggregate vectors corresponding to the generated vector for each unique log key, the aggregated vectors forming a data matrix including rows for each unique log key;
perform median normalization on the values of the data matrix to provide a normalized data matrix;
determine a minimum covariance determinant of the values of the normalized data matrix; and
filter rows of the normalized data matrix based at least in part on a Mahalanobis distance of the rows being greater than a predetermined threshold, the predetermined threshold being determined based at least in part on the minimum covariance determinant.

14. The system of claim 11, wherein to determine the probabilities of the set of log lines occurring within the predetermined window of time is based on a long short-term memory network.

15. The system of claim 11, wherein to determine the probabilities of the set of log lines occurring within the predetermined window of time is based on a feed-forward neural network.

16. The system of claim 11, wherein the different periods of time correspond to a number of respective consecutive periods of time occurring after each log line, and the probabilities of different periods of time correspond to a probability distribution over the different periods of time.

17. The system of claim 11, wherein to detect the anomaly when the actual subsequent log line differs from the predicted subsequent log line further causes the processor to:
detect the anomaly when the actual subsequent log line differs from the predicted subsequent log line and a probability associated with the predicted subsequent log line exceeds a threshold.

18. The system of claim 15, wherein the memory device includes further instructions, which when executed by the processor, further cause the processor to:
send a notification in response to the detected anomaly.

19. The system of claim 18, wherein to segment respective log lines from the log file into respective sequences of log lines further causes the processor to:
match a log line to a particular sequence of log lines based on a score.

20. A non-transitory computer-readable medium comprising instructions, which when executed by a computing device, cause the computing device to perform operations comprising:
extracting features from each log line of a log file;
determining, based on the extracted features, a sequence of log lines, the sequence of log lines including multiple log lines that occur in chronological order;
determining, for each respective log line from the sequence of log lines, probabilities of a set of log lines occurring within a predetermined window of time from the respective log line from the sequence of log lines;
determining, for each respective log line from the sequence of log lines, probabilities of different periods of time within the predetermined window of time that a next log line will occur after the respective log line from the sequence of log lines;
segmenting respective log lines from the log file into respective sequences of log lines based at least in part on the probabilities of the set of log lines occurring within the predetermined window of time and the probabilities of different periods of time that the next log line occurs after the respective log line;
determining a predicted subsequent log line based at least in part on an actual log line from the respective sequences of log lines and a second predetermined window of time; and
detecting an anomaly when an actual subsequent log line differs from the predicted subsequent log line.
